(19) United States
(12) Patent Application Publication
(10) Pub. No.: US 2024/0346482 A1
(43) Pub. Date: Oct. 17, 2024

(54) SYSTEM AND METHOD FOR MANAGING PAIRED A PHYSICAL TAG AND A NON-FUNGIBLE TOKEN.

(71) Applicant: Timothy Christopher Bodenmiller, Sanford, CA (US)

(72) Inventor: Timothy Christopher Bodenmiller, Sanford, CA (US)

(21) Appl. No.: 18/301,794

(22) Filed: Apr. 17, 2023

Related U.S. Application Data
(60) Provisional application No. 63/311,334, filed on Feb. 17, 2022.

(51) Int. Cl. G06Q 20/36; G06Q 20/40; H04L 9/08

(52) U.S. Cl. CPC G06Q 20/36; G06Q 20/401; H04L 9/0825; G06Q 2220/00; H04L 2209/60

(57) ABSTRACT

A system and method for managing a combination of a physical tag and a non-fungible token (NFC), the physical tag can be applied to an article for which the NFT is generated. The system can verify the authenticity of the physical tag and current ownership of the article. The contract and/or wallet address and the token ID can be incorporated into the physical tag applied to the article in the form of a URI. For the verification, the URI can be read by a used device, and the validity and association of the contract and/or wallet address and the token ID can be checked by the system in published NFT transactions.

### CROSS-REFERENCE TO RELATED APPLICATIONS

This application claims priority from of a U.S. Patent Application Ser. No. 63/311,334, filed on Feb. 17, 2022, the disclosure of which is hereby incorporated by reference in its entirety.

### FIELD OF INVENTION

The present invention relates to authenticating physical tags using NFTs, and more particularly, the present invention relates to a system and method for managing paired physical tags and digital NFTs.

### BACKGROUND

Non-Fungible tokens have become quite popular in the digital world and have been used by artists, producers, and the like for a variety of digital products, such as paintings, photographs, songs, stories, and the like. The usefulness and authentication of ownership provided by the NFTs have been proven beyond any doubt.

There have been efforts in the art to use digital NFTs to authenticate ownership of physical articles, especially luxury and limited collection articles. Examples of such articles include costly paintings, limited shoe collections, and the like. Typically, the NFTs are minted for each article and a certificate showing the same is provided with the article. Physical tags that can be attached to the article informing about the NFT are also known. However, such methods suffer from several drawbacks and limitations. The primary drawback is the lack of means to authenticate the certificate or physical tags. The physical tags are coupled to the article; however, these cannot be verified.

A need is therefore appreciated for a system and method for authenticating/verifying the physical tags associated with digital NFTs.

The term physical tag is also referred to herein as the physical NFT or pNFT. The digital NFT is also referred to herein as NFT or dNFT.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method to verify and certify the origin and authenticity of a physical tag based on its associated/paired digital NFT.

It is another object of the present invention to ensure that the current ownership of the physical tag and dNFT are the same and unique.

It is another object of the present invention that the system and method can be versatile by adapting to different blockchains and wallets.

It is still another object of the present invention that the link between creator and object can be maintained.

It is yet another object of the present invention to provide services based on the level of authentication and ownership.

It is a further object of the present invention to provide access to social groups, forums, events, and the like based on the current and past ownership.

It is still a further object of the present invention that the information can be shared based on the physical NFTs.

A system and method for managing a combination of a physical tag and a non-fungible token (NFC), the method implemented within a system comprising a processor and a memory, the method comprising receiving details of an NFT for a physical article, the details comprise a contract and/or wallet address, wherein the NFT has a token ID; incorporating a URI into a physical tag, the URI comprises a network address of the system, the contract and/or wallet address, and the token ID arranged in a predefined syntax, the URI is configured to be read by a user device, the physical tag is configured to be applied to the physical article; receiving, by the system, from the user device, through the URI read by the user device from the physical tag, the contract and/or wallet address and the token ID; verifying, by the system, the validity of the contract and/or wallet address; verifying, by the system, an association of the token ID with the contract and/or wallet address; and upon verification, presenting, by the system, a first screen on the user device. The method further comprises incorporating, a copy of a UUID of the physical tag in an unlockable section of the NFT, wherein the unlockable section of the NFT is configured to be accessed only by a current owner of the NFT, the UUID is a unique code stored in the physical tag in an encrypted form, the UUID is encrypted using a private key; and incorporating the private key into the unlockable section.

The method further comprises generating, the NFT comprising the unlockable section, the unlockable section comprising the copy of UUID and the private key. The method further comprises receiving, the copy of UUID and the private key from the user device; receiving, the encrypted UUID read by the user device from the physical tag; decrypting the encrypted UUID using the private key; matching the copy of the UUID and the decrypted UUID; and upon a match, presenting a second screen on the user device. The method further comprises checking the presence of the token ID in any of one or more wallets; and upon presence, presenting a second screen on the user device. The first screen is configured to provide access to a set of first services, the second screen is configured to provide access to a second set of services, the second set of services is different from the first set of services.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is an environmental diagram of the system, according to an exemplary embodiment of the present invention.

FIG. 2 is a flowchart showing a first level of authentication, according to an exemplary embodiment of the present invention.

FIG. 3 is a flowchart showing a second level of authentication, according to an exemplary embodiment of the present invention.

FIG. 4 is a flowchart showing an alternate method for the second level of authentication, according to an exemplary embodiment of the present invention.

FIG. 5 illustrates a first screen presented on a user device, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a system and method for managing a paired physical tag and a digital NFT. The disclosed method allows for verifying the physical tag based on the paired/associated NFT. The disclosed method can authenticate the link between the creator and the physical tag. The physical tag can be applied to any article for which the NFT is generated.

Generally, a creator can create an NFT for a physical article. The physical article can be anything, such as a painting, garment, footwear, timepiece, watch, and the like. It may be desirable that the NFTs are generated for limited availability products, such as precious paintings, limited collection shoes, and the like. The creator of the NFT can be the manufacturer of the article, a seller, or an owner of the article. The creator can create the NFT through the disclosed system. Alternatively, any crypto wallet and blockchain system can be used to mint the NFT. In such a case, the information about the NFT can be received by the system. The creator can use anything digital related to the article to create the NFT, such as a photograph of the article. For example, a photograph showing a shoe from a collection that has further details such as the tenth shoe in a collection with a logo and like can be used to create an NFT. While creating the NFT, other details of the article and of the manufacturer of the article can also be added. The NFT also contains an unlockable content feature in which a UUID and encryption keys (explained later) can be stored.

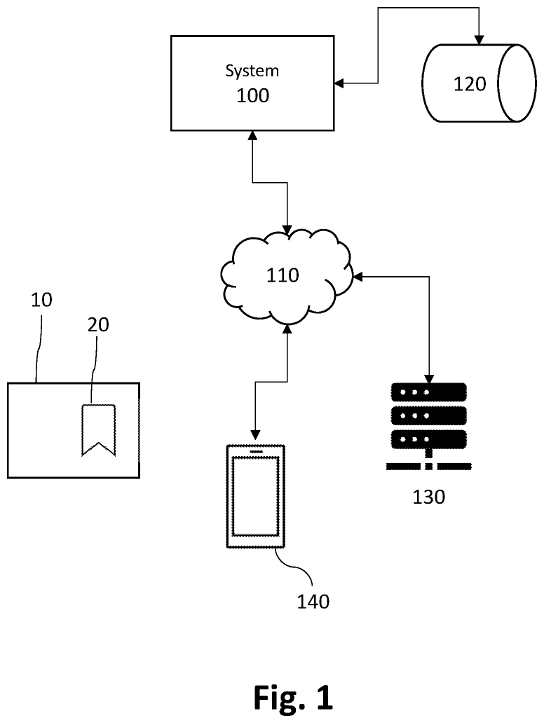

When the NFT is minted by the creator, the contract and/or wallet address(es) of the creator and the NFT token ID is published in the public domain and is searchable. The minting of NFTs and searching of such transactions is well known in the art. The disclosed system can add such transactions including the contract and/or wallet address(es) and the token ID in a quarriable database, and any such database is within the scope of the present invention. FIG. 1 shows the system 100 connected to a database 120 and a blockchain server 130.

The disclosed system can also provide for configuring the physical tags based on the NFT to be associated with the physical tag. The physical tag can be applied to the article in one of the many ways. Preferably, the physical tag can be applied in a tamperproof manner. Also, depending upon the article to which the physical tag is to be applied, the physical tags can be made durable. For example, the physical tag for a shoe may be more durable than the physical tag for a painting. The physical tag can include memory for storing information, wherein the physical tag and the memory may support suitable encryption. Preferably, the physical tags may support the hardware level of encryption. The physical tag may also include suitable circuitry that allows writing information to the memory and allows an external device to read the information from the memory. For example, a suitable NFC/RFID chip may be integrated into the physical tag and an external NFC device can read the information from the physical tag. Moreover, the physical tag can be applied to the article before or after getting configured by the system.

The system can have information about the NFT including the contract and/or wallet address(es) of the creator of the NFT, the token ID of the NFT, and the UUID stored with the NFT, and such information can be used to configure the physical token that is applied or is to be applied to the article for which the NFT is generated. The system may receive such information from the minting platform or the creator. The system can store the information in the physical tag such that it can be accessed by an external device, such as a smartphone. Preferably, the UUID can be stored in an encrypted form. UUID can be a unique code made from alphabets, numbers, symbols, and the like, and can be of any length. For example, the UUID can be randomly generated by the system. It is preferable that the UUID can be of such length and can include alphanumeric characters that can be compatible with the NFT and could be copied and pasted using a clipboard of any external device such as a smartphone. A suitable example of encryption includes PGP encryption. The system may have the required keys to decrypt the UUID and read the same from the physical tag. In certain implementations, the encryption can be hardware-based to prevent duplication of the physical token. The UUID can be contained within the physical tag in the encrypted form, and a copy of the UUID along with the private key used for encryption can be received by the system and the same can be stored in the unlockable section while minting the NFT. Thus, the copy of the UUID and the private key may be only in the NFT and only the current owner of the NFT has access to them. The system may not store the same i.e., the UUID and the key.

A user who can be the creator of the article, the current owner of the article, or any user in possession of the article can check the pairing of the physical tag with the digital NFT using the disclosed system. The user can verify the physical tag based on its associated NFT and the link between the creator and the article. The user can use any computing device, referred to herein as a user device, provided the user device is compatible to read the physical tag. For example, for the physical tag having the NFC, the user device must be NFC equipped. Examples of user devices include smartphones, smart watches, tablet computers, and the like.

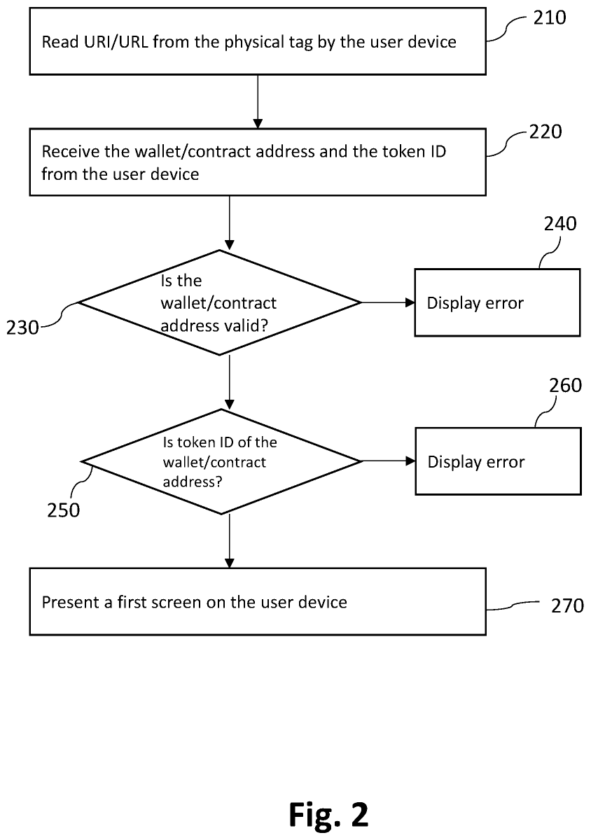

Referring to FIG. 2 is a flow chart showing the process for the first level of authentication. First, the user using the user device can read URI/URL from the physical tag, at step 210. For example, the user can tap a smartphone on the NFC-enabled physical tag to read information. The URI can include an address of the system allowing the user device to connect with the disclosed system through the suitable network. For example, FIG. 1 shows the user device 140 connected to the system 100 through the network 110. To the URI can be appended the contract and/or wallet address(es) and the token ID. The URI can include such information and the URI can be stored in the physical tag. The system can receive the contract and/or wallet address(es) and the token ID from the user device, at step 220. The system can receive the appended data through suitable methods, and such methods are known in the art. The URI can indicate that appended are the contract and/or wallet address(es) and the token ID which need to be verified. The system upon receiving the said information can check if the contract and/or wallet address(es) is valid and registered, at step 230. If the contract and/or wallet address(es) could not be verified, an error can be displayed on the user device by the system, at step 240. However, upon successful verification of the contract and/or wallet address(es) by the system, the system can check if a transaction exists having the contract and/or wallet address(es) and the token ID, at step 250. If no such transaction could be found by the system, an error can be displayed on the user device, at step 260. If the token ID can be found associated with the contract and/or wallet address(es), the system can display a first screen on the user device, at step 270. Also, the system can optionally show a message indicating that the first level of authentication is successful.

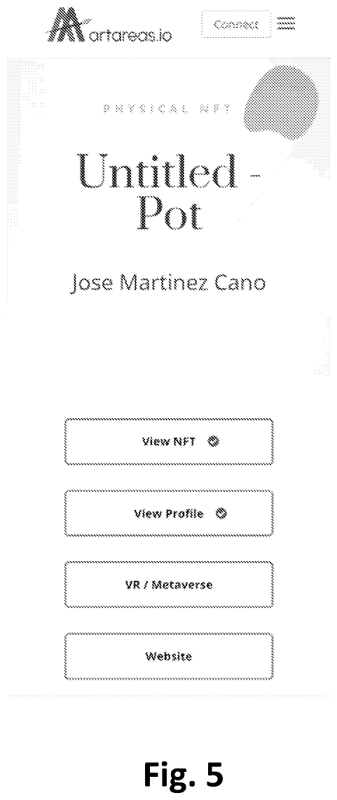

Through the first screen, the user can access a host of services wherein the list of such services can be provided on the screen. FIG. 5 shows the first screen. The user can select the desired service, for example, by activating a soft button associated with the service. The system upon receiving the selection of the service from the first screen can implement the selected service. For example, the user can view the NFT record including the name of the creator and other details in the NFT that are public. The services provided on the first screen are based on the first level of authentication. The said services can be accessed by the users in possession of the article, but the users may not be the owners of the article. Scanning the physical tag may ensure they have the article and are close to it while accessing the services.

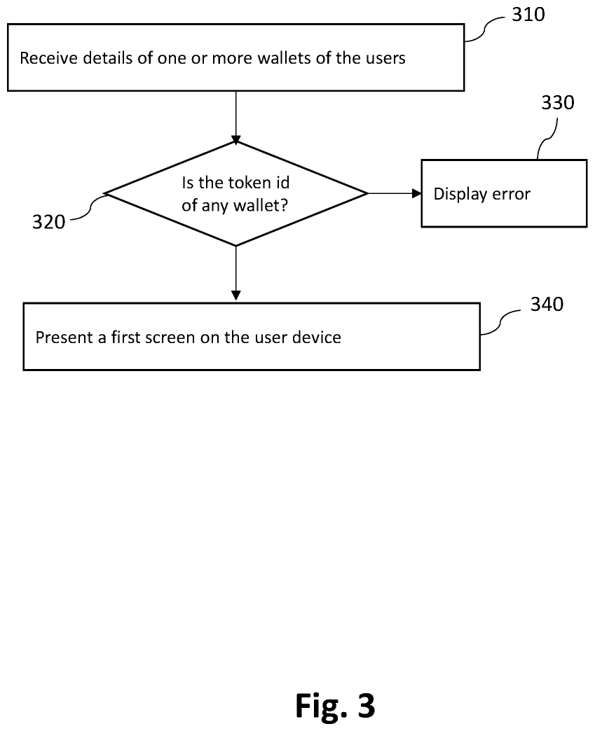

The user can also be provided with an option to further verify that the user has the article and that the user is the current owner of the article. As shown in FIG. 3, the system can receive details of one or more wallets of the users, at step 310. Upon receiving the details, the system can check if the token id received from the physical tag is currently present in any of the one or more wallets of the user, at step 320. If the token could not be found in the wallets of the user, an error can be displayed on the user device, at step 330. Alternatively, if the token could be found, authenticating the user as the current owner of the article, a second screen can be displayed on the user device replacing the first screen, at step 340. The second screen can have additional services for the user to select from, wherein the additional services are based on the second level of authentication.

In certain implementations, the disclosed system can check if the user is or was the owner of the article. The system can receive one or more contract and/or wallet address(es) of the user and can check if the contract and/or wallet address(es) and the token ID are linked in the NFT transactions.

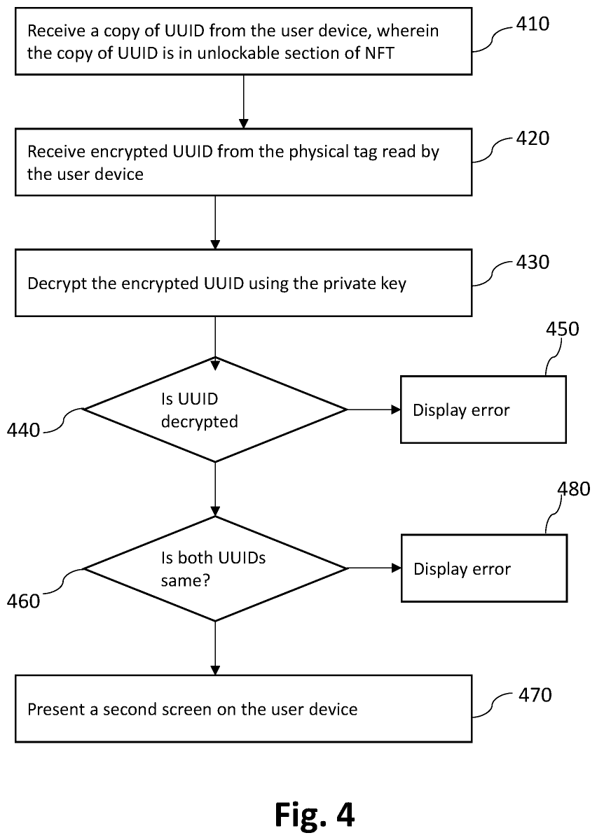

Referring to FIG. 4 shows an alternate method for the second level of authentication. In such a case, the system can receive a copy of UUID from the user device, at step 410, wherein the UUID is received from the unlockable content of NFT. Since the unlockable content of the NFT can be accessed only by the current owner, the receiving of UUID from the user can authenticate that the user is the current owner of the NFT. The system can also receive a private key of the encrypted UUID of the physical tag from the NFT. The system can also receive the encrypted UUID from the physical tag as read by the user device, at step 420. It is to be noted that the private key can be stored by the system instead of in the NFT. The decryption of the UUID from the private key can further authenticate the physical tag identity and validity. This may also prevent duplication of the physical tag. The encrypted UUID can be decrypted at step 430. If the UUID is not decrypted at step 440, an error can be displayed on the user device, at step 450. If the UUID is decrypted at step 440, the system can match the copy of UUID and the decrypted UUID, at step 460. Upon a successful match, the second screen can be presented on the user device, at step 470. However, if the match is not successful at step 460, an error can be displayed on the user device, at step 480. It is obvious that the user can retry the authentication process.

In certain implementations, the disclosed system can check authenticity using combined processes as described in FIGS. 3 and 4. The system can check the token ownership in the user's wallet as described in FIG. 3 and match the UUID as described in FIG. 4. The two verification processes can be performed in any order; however, it may be preferred that the token ownership can be checked first and then the UUID can be compared. When verification is done by the above two processes consecutively, the system can present a third screen on the user device, wherein the third screen may have additional services for the user.

In certain implementations, the disclosed system can be advantageous by allowing any crypto wallet to be used for minting the NFTs. The NFT information to be incorporated into the physical tag can be obtained by the system, the information can be the minting contract and/or wallet address(es), token ID, and UUID. The UUID can be randomly generated by the system or by any other source. The UUID, in encrypted form, can be present in the physical tag and the copy of UUID and the respective private key can be received by the system and incorporated into the unlockable section of the NFT.

In certain implementations, the NFT can have unlockable content that can be accessed only by the current owner of the NFT. In the unlockable content, the UUID and encryption keys can be stored. The encryption key can be for the encrypted UUID of the physical tag.

In another implementation, the NFT can be minted by creating a unique contract, in which case, the NFTs may be minted into a wallet owned by the creator, or they may be minted directly into a recipient's wallet. In this case, the contract address from which the NFTs originate is tied to creator, but the initial wallet address may or may not be tied to the creator.

Level 1 authentication can at least ensure that the user has physical access to the object, the user may or may not be the owner. Having the article, the user can have access to certain services provided by the system, wherein such services can be accessed through the first screen. An exemplary embodiment of the first screen is shown in FIG. 5. The user can check the NFT and profile using the first screen. The options having the checkmark in front of them can only be accessed by the user. On the second screen, all of the options are available to the user i.e., the VR/metaverse and the website. The system may define how, when, or where options, information, or functionality can be made available. Examples of services and information that can be made available to the users may include any special information, access codes, interactive elements, etc., links to the associated NFTs and wallet profiles, a link into a VR environment or location in the metaverse, access to a live online event, chat room, discord server, etc. The user can request level 2 authentication using the first screen.

In certain implementations, the owners of articles as verified by the system using the level 2 authentication can determine the features, services, and limitations in the first screen. Authenticated as the owner of an article, the owners can include the ability to add options, information, or functionality accessible to users who only have physical access, and the owner could also set conditions on how, when, or where a user must be to access options, information, or functionality. For example, a certain button on the menu may only be available during specific times or might disappear from the menu if the user left the area where the physical object resides. Another example might be to allow certain options, information, or functionality to only be presented to specific people (identified by wallet addresses they would have to log in with, or perhaps they might need to own a different token from the same source).

It is an advantage to use a contract and/or wallet address(es) for verification as it can inform about the origin of the article i.e., the creator who created the NFT. The minting contract and/or wallet address(es) of each Digital NFT can be from a contract and/or wallet address(es) unique to the true source of the physical object, whether it's an artist, entertainer, celebrity, athlete, organization, etc., it better provides for the authenticity of the source of the physical article/object.

A unique set of keys is generated for every paired Digital NFT and Physical tag, this helps protect each item significantly better since the NFT encryption would need to be broken for every NFT individually, it allows for future NFT pairs to use stronger encryption as needed. The PGP key that would normally be public is kept private and used only by the owner to verify that the Physical tag and Digital NFTs are a matched pair.

The disclosed system and method allow a physical article or object to be represented by a digital NFT using a physical tag. The disclosed system and method allow authenticating the origin and current ownership of the article based on the NFT. For example, VR/Metaverse spaces allow a digital NFT to be displayed. The incorporation of the token id and contract and/or wallet address(es) in the physical tag in unencrypted form allows sharing of the public identity of the physical article through the associated NFT. This makes possible one level of pairing and authentication for those with physical access but who isn't the owner, while providing a deeper level of pairing for the owner of the object, as designated by ownership of the Digital NFT, whose owner alone can unlock the verification key and UUID in the Digital NFT, and then verify the encrypted UUID.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for managing a combination of a physical tag and a non-fungible token (NFC), the method implemented within a system comprising a processor and a memory, the method comprising:
receiving details of an NFT for a physical article, the details comprise a contract and/or wallet address, wherein the NFT has a token ID;
incorporating a URI into a physical tag, the URI comprises a network address of the system, the contract and/or wallet address, and the token ID arranged in a predefined syntax, the URI is configured to be read by a user device, the physical tag is configured to be applied to the physical article;
receiving, by the system, from the user device, through the URI read by the user device from the physical tag, the contract and/or wallet address and the token ID;
verifying, by the system, the validity of the contract and/or wallet address;
verifying, by the system, an association of the token ID with the contract and/or wallet address; and
upon verification, presenting, by the system, a first screen on the user device.

2. The method according to claim 1, wherein the method further comprises:
incorporating, a copy of a UUID of the physical tag in an unlockable section of the NFT, wherein the unlockable section of the NFT is configured to be accessed only by a current owner of the NFT, the UUID is a unique code stored in the physical tag in an encrypted form, the UUID is encrypted using a private key; and
incorporating the private key into the unlockable section.

3. The method according to claim 2, wherein the method further comprises:
generating, the NFT comprising the unlockable section, the unlockable section comprising the copy of UUID and the private key.

4. The method according to claim 2, wherein the method further comprises:
receiving, the copy of UUID and the private key from the user device;
receiving, the encrypted UUID read by the user device from the physical tag;
decrypting the encrypted UUID using the private key;
matching the copy of the UUID and the decrypted UUID; and
upon a match, presenting a second screen on the user device.

5. The method according to claim 1, wherein the method further comprises:
checking a presence of the token ID in any of one or more wallets; and
upon presence, presenting a second screen on the user device.

6. The method according to claim 4, wherein the first screen is configured to provide access to a set of first services, the second screen is configured to provide access to a second set of service, the second set of services is different from the first set of services.

7. A system for managing a combination of a physical tag and a non-fungible token (NFC), the system comprising a processor and a memory, the system configured to implement a method comprising:
receiving details of an NFT for a physical article, the details comprise a contract and/or wallet address, wherein the NFT has a token ID;
incorporating a URI into a physical tag, the URI comprises a network address of the system, the contract and/or wallet address, and the token ID arranged in a predefined syntax, the URI is configured to be read by a user device, the physical tag is configured to be applied to the physical article;
receiving, by the system, from the user device, through the URI read by the user device from the physical tag, the contract and/or wallet address and the token ID;
verifying, by the system, validity of the contract and/or wallet address;
verifying, by the system, an association of the token ID with the contract and/or wallet address; and
upon verification, presenting, by the system, a first screen on the user device.

8. The system according to claim 7, wherein the method further comprises:
incorporating, a copy of an UUID of the physical tag in an unlockable section of the NFT, wherein the unlockable section of the NFT is configured to be accessed only by a current owner of the NFT, the UUID is a unique code stored in the physical tag in an encrypted form, the UUID is encrypted using a private key; and
incorporating the private key into the unlockable section.

9. The system according to claim 8, wherein the method further comprises:
generating, the NFT comprising the unlockable section, the unlockable section comprising the copy of UUID and the private key.

10. The system according to claim 8, wherein the method further comprises:
receiving, the copy of UUID and the private key from the user device;
receiving, the encrypted UUID read by the user device from the physical tag;
decrypting the encrypted UUID using the private key;
matching the copy of the UUID and the decrypted UUID; and
upon a match, presenting a second screen on the user device.

11. The system according to claim 7, wherein the method further comprises:
checking presence of the token ID in any of one or more wallets; and
upon presence, presenting a second screen on the user device.
The system according to claim 10, wherein the first screen is configured to provide access to a set of first services, the second screen is configured to provide access to a second set of service, the second set of services is different from the first set of services.
